(19) United States
(12) Patent Application Publication
(10) Pub. No.: US 2010/0301064 A1
(43) Pub. Date: Dec. 2, 2010

(54) MIXING APPARATUS

(76) Inventor: Herbert John Munro, Oamaru (NZ)

Correspondence Address: GREER, BURNS & CRAIN, 300 S WACKER DR, 25TH FLOOR, CHICAGO, IL, 60606, US

(21) Appl. No.: 12/745,071

(22) PCT Filed: Nov. 27, 2008
(86) PCT No.: PCT/NZ2008/000318

§ 371 Date: Jul. 8, 2010

(30) Foreign Application Priority Data
Dec. 3, 2007 (NZ) 564047

(51) Int. Cl. B67D 7/00; B67D 7/78; B67D 7/70; B67D 7/08

(52) U.S. Cl. 222/1; 222/145.5; 222/135

(57) ABSTRACT

A method and apparatus for delivery of a plurality of input fluids, at least two of which are liquids, in a foam delivery system, including a fluid controller having: a delivery mechanism for each fluid, at least one test parameter transducer for each fluid configured to measure a test parameter associated with each fluid, and a control system configured to receive the output of each test parameter transducer and to issue a termination signal configured to stop each of the delivery mechanisms if the measured parameter deviates from a preset range of values.

### TECHNICAL FIELD

The invention relates to a mixing apparatus. In particular the invention relates to a portable mixing apparatus for mixing a plurality of fluids to produce foam insulation incorporating a method of providing independent Quality Control on a remote building site.

### BACKGROUND ART

There is an increasing awareness that energy use in dwellings can and should be reduced by provision of adequate thermal insulation. For example, regulations have recently been introduced into New Zealand that require inclusion of appropriate insulation in all new dwellings. This can include insulation in wall cavities, ceiling spaces and under flooring, as well as double glazing of windows in some regions.

While it is relatively straight forward to install insulation at the time of construction of a building, this generally is not the case for existing structures. However, existing structures far outnumber new buildings and therefore retrofitting of insulation in existing structures presents a significant opportunity to contribute towards energy conservation, as well as reduced cost in energy use by the occupants of the building.

There are many current methods for retrofitting insulation into areas where access is available, such as most ceiling spaces. However, this becomes more difficult when ready access into the space is generally not available, such as into wall cavities.

One well known system for retrofitting insulation into difficult to access spaces involves injection of a foam insulating material. In this system typically two liquid materials are mixed together with air (or some other gas) to produce a foam. A wide range of materials can and have been used for this purpose. Generally one liquid material contains a resin of some kind and the other liquid material can include a catalyst and foaming agent.

When mixed together with a gas, such as air, the two liquid materials produce a foam that gels (sets) in a relatively short time (the gel time) to provide a solid foam. The quantities of materials to be mixed can be chosen such that the resultant foam is fluid for a sufficient period of time to allow the foam to be pumped into a space to be insulated and for the foam to substantially fill that space prior to the gel time.

The mixing typically occurs in a mixing gun. This is generally done in two stages. In the first stage air is mixed with a first liquid which contains a foaming agent to produce a foam. The first liquid typically also contains a catalyst, water and a water conditioner. In the second stage the second fluid, which contains a resin, is mixed with the foam produced in the first stage.

The combined foam is then released into a cavity through a nozzle attached to an extension of the mixing gun.

The density of the resultant (cured) foam is important. Generally the density for any particular solid foam material needs to be within a narrow range around an optimum density in order for the foam to provide the desired thermal, structural and acoustical (in instances where sound reduction is desired) properties. Variations in foam density outside the desired range can lead to a drop in thermal insulation and a decrease in structural integrity of the foam—for example total collapse (foam doesn't stay formed) or crumbling of the foam—which can result in a loss of thermal/acoustical insulation throughout much of the cavity.

In typical operations the two fluids are provided in a form such that the correct chemical balance (i.e. correct quantities of each component (resin, catalyst, foaming agent, water conditioner and water)) to produce the required foam is achieved by mixing substantially equal amounts of each liquid with an appropriate amount of air (or other gas).

In some instances an operator may need to adjust the composition, for example by adding water or other chemicals, to provide the correct mixture for the prevailing conditions. For example the viscosity of one or other of the liquids can be adjusted to compensate for the ambient temperature.

The amount of air mixed with the two fluids is critical—too much air will increase the volume of foam, leading to a drop in density, while too little will result in less volume of foam leading to an increase in density. The main disadvantage with too little air (high density foam) is that more fluid material, particularly resin, is required for the same volume of foam, leading to increased material costs.

The mixing process is further complicated in that the mixing ratios depend on the flow rate of the liquids into the mixing chamber and the rate at which the resultant foam flows from the nozzle.

A typical arrangement for producing foam insulation for on-site installation, as currently used, includes two pressurised reservoirs, one for a liquid containing resin and one for a liquid containing a catalyst (among other components). Compressed air from a compressor can be used to pressurise the interior of each reservoir, with the outlet pressure controlled by a regulator on each reservoir.

In other cases the liquid can be provided in pressurised canisters, or may be pumped, for example using a rotary or diaphragm pump. Typically in each case the pressure is controlled with a regulator.

Liquid flow from each reservoir is further controlled by an on/off valve. With the valves open the liquids from each pressurised reservoir flow along separate hoses to the mixing gun. Another hose delivers compressed air from the compressor to the mixing gun.

The mixing gun typically has three valves, one for each hose. During operation an operator manually adjusts the air valve to maintain the required amount of air to provide the desired density of foam. A gauge is used to monitor the pressure of the air.

Prior to the start of foam installation, an operator typically needs to set up and calibrate the various components of the system to produce the desired consistency and density of the foam.

In a typical situation this can involve mixing each of the liquids to provide the required composition for the particular job. For example, the resin may be delivered to the site in a concentrated form, in which case an operator typically adds heated water to the concentrate to obtain the desired temperature and consistency of the liquid resin.

Similarly, the operator can mix the second liquid on site. Again heated water is used to provide the appropriate temperature. Typically a catalyst is added to the water along with water conditioner to provide the required conditions for foam creation. At this stage the amount of the various chemicals, such as the catalyst, may be varied to provide the desired characteristics for the particular job. For example the amount of catalyst may be varied to provide a particular gel time for the foam (when mixed with resin and air or other gas).

Having mixed the chemicals for each liquid and checked the temperatures of the liquids in each reservoir, the operator then connects the reservoirs to a compressor (or other source of pressurised air) and sets the pressures in each reservoir to the required initial values.

The next step is to adjust the pressure regulator for each liquid on each reservoir to provide the correct ratio of liquids (typically around 1:1). This can be done by adjusting the flow of resin first until the desired flow rate is achieved. The amount of resin flowing through the gun in a given time (say 30 seconds) can be measured by the operator (for example by directing the resin into a calibrated vessel or by weighing the amount of resin as a function of time) and the flow rate adjusted until the desired rate is established.

The operator can then adjust the pressure regulator for the second liquid until the same volume of the second liquid is provided in the set time. Once the pressure regulators controlling the liquids have been set for the required flow, they remain in that position for the duration of the job (or until another batch is mixed and the set up process repeated).

The operator can then adjust the valve controlling the compressed air into the gun to provide the correct consistency of foam. This can be tested by producing foam from the nozzle and visually inspecting it to ensure the consistency is acceptable.

The final step is to set the density of the foam, which can be tested by filling a test cavity of known volume (for example a bucket) and measuring the weight of the foam. If necessary the amount of air can be manually adjusted and the process repeated until foam of the correct consistency and density is achieved.

This set up process is critical to the delivery of foam of the correct consistency and density into the cavity to be filled. However, the set up process is dependent on the skill, experience and dedication of the operator. If insufficient care is taken, or the operator is not skilled in visually assessing the condition of the foam, the result can be delivery of foam that does not fulfil the requirements for the job (i.e., long lasting thermal/acoustical insulation).

A further problem is the time required to set up the equipment at the start of each job (or each new batch of liquids). This can typically take around 45 minutes, which can add considerably to the labour cost of each job.

Ideally, with the apparatus set up to deliver foam of the correct consistency and density it should only be a matter of inserting the nozzle of the gun into the cavity and allowing the foam to flow.

However, in a highly interdependent, pressurised, multi-component dynamic system such as described above, variations can occur which result in the density of the foam moving away from the desired value.

A change in pressure of any of the components can result in an alteration in the ratio of the amounts of the liquids, taking the mixture away from the correct chemical balance. For example if the air pressure in the gun builds above the desired value, not only will an excess of air be blown into the foam (leading to lower density foam) but also the excess pressure in the gun will create a backpressure on the liquid in the hoses. As the liquids generally have differing viscosities (the resinous liquid generally having a viscosity similar to light oil, while the liquid containing the catalyst is water-like) this can lead to an imbalance in the quantity of each liquid entering the mixing gun upsetting the chemical balance of the foam. Both of these effects can lead to poor quality foam, i.e., foam that does not provide the desired properties (structural as well as thermal).

The problem is exacerbated in that in typical installations the operator is not able to visually check the foam in the cavity.

Successful operation of such foam insulation machines is therefore highly dependent on the skill of the operator. Not only must the operator set up the system correctly in the first instance, but also each of the critical parameters (at least the flow rate of the air) must be monitored continuously and appropriate adjustments made as required in order to deliver foam of the required consistency. This is not easy to achieve even with a well trained operator, as, by the nature of, the work, the operator's attention is generally focussed on the nozzle end of the gun to ensure the foam is flowing properly into the cavity.

In practice, even a skilled operator may only check the air pressure gauge at intermittent intervals and therefore may not realise that a problem has arisen until a significant amount of poorly formed foam has been installed. The potential for poor installation is clearly more extreme if the operator is not skilled or properly trained.

Another problem can arise if an operator uses fewer raw materials (resin or catalyst), or adds an excess of air in the foam, in order to save on the cost of materials.

The resulting foam will generally be below the required density, which can lead to a loss of structural integrity. This can result in gaps in the foam and in extreme cases the foam crumbling and falling apart,

This deterioration of the foam can take place gradually, so the loss of insulation (due to collapse of the foam or crumbling) may not be noticed until some considerable time after the installation is completed. As in most cases the foam is inside a cavity and not readily visible, the problem may not be readily apparent, for example to an occupant of a foam insulated dwelling. In such cases the occupant can conclude that foam insulation doesn't work or at best only has a limited lifetime.

In other instances an imbalance in the mixture, for example too much resin, can lead to the foam becoming unstable and collapsing. This generally happens when foam is formed but may not be noticed by the operator if the foam is hidden from view (a typical situation). This can result in a void in the foam and subsequent loss of effectiveness.

On the other hand, too much catalyst (for the amount of resin) can lead to the formation of foam having a large cell size (in comparison with the cell size for foam of the desired consistency), which lowers the density of the foam and reduces its effectiveness.

Whatever the cause, any failure of the foam can lead to bad publicity for foam insulation as a process, which can have a severe detrimental effect on the entire industry and result in fewer structures being insulated with foam.

In summary, the prior art processes lack sufficient Quality Control to ensure the installed insulation is of the desired standard.

A further disadvantage with the existing systems is the time required to clean up and dismantle the apparatus at the finish of a job. For example, any remaining foam must be cleaned from the mixing gun before it gels, all liquids must be removed from the hoses and reservoirs, and everything cleaned prior to the start of the next job. Typically the time spent on setting up and calibrating the equipment prior to starting each job, and cleaning up after each job, accounts for around 3 person hours in a typical working day. This can add significantly to the cost of installation.

A further disadvantage is that, because the gel time is relatively short (typically 20 to 90 seconds, depending on the amount of catalyst in the mixture), any break in injection of the foam once production starts requires that the foam in the gun must be purged before it gels. This can be achieved by turning off the liquids and blowing air through the gun to force surplus foam out (into a waste bag, for example). Again, this process, including re-establishing the correct operating conditions when restarting foam production, requires time and leads to wasted materials, which add to the cost of installation.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is a method of delivering foam insulation into a cavity, the foam being formed from a plurality of fluids, at least two of which are liquids,

having the steps of
a) receiving each fluid into a fluid controller, and
b) forming a foam in a mixing chamber by combining the fluids received from the fluid controller, and
c) delivering the formed foam into the cavity

characterised by the steps of
d) measuring a test parameter for each fluid in the fluid controller and
e) stopping delivery of all fluids if the measured test parameter of any fluid falls outside of a preset allowed range of values for that fluid

wherein steps d) and e) are preformed independently of an operator.

In a preferred embodiment the foam delivery system is a foam insulation system.

Reference throughout this specification to a foam insulation system should be understood to refer to a system for mixing at least two composite liquids with air to produce foam. In particular the foam insulation system of the present invention is intended for use in production of foam for on-site installation into a cavity, preferably a cavity in a structure, for example the cavity between an inner wall lining and the outer cladding of a building. It should be appreciated however that the present invention is not limited to delivering foam insulation into a wall cavity but can be used to deliver foam to any cavity in buildings or other structures.

Typically the foam is used to provide thermal (and/or acoustical) insulation and may also include a fire retardant.

In a preferred embodiment a first liquid includes a catalyst.

In a preferred embodiment a second liquid includes a resin.

In a preferred embodiment the resin is urea formaldehyde.

In a preferred embodiment one fluid is air.

The production of foam insulation requires the mixing of (at least) three fluids, two in the form of liquids and one gas (air). A first liquid (A) typically includes a catalyst and foaming agent in aqueous solution, and may also include a water conditioner and other chemicals as desired. A second liquid (B) typically includes a resin.

The resin containing liquid (the second liquid (B above)) preferably includes urea formaldehyde as the resin component. Solutions containing urea formaldehyde are specifically formulated to produce foam insulation suitable for application into cavities in buildings. However, the resin containing liquid may contain resin formulations other than urea formaldehyde as are well known by those skilled in the art, and reference to resin containing liquid including urea formaldehyde only throughout this specification should not be seen as limiting. Indeed, typically the resin containing liquid may be formulated specifically for different countries/regions, depending on such things as local climate, or different applications, such as local construction practices (ie, nature of building materials used etc).

In a preferred embodiment the mixing chamber is the mixing chamber of a mixing gun.

Reference to a mixing gun throughout this specification should be understood to refer to any device configured to mix fluids to produce foam.

Steps a) to c) of the present invention are characteristic of prior art systems. Steps d) and e), which are to be carried out independently of an operator of the system, involve quality control measures that are absent in the prior art systems. These steps involve automatic measurement of a test parameter for each fluid and stoppage of the system if any test parameter falls outside of an allowed range of values for that test parameter for that fluid. In this manner the delivery of the foam making constituents to the mixing chamber can be controlled automatically to ensure that the correct conditions apply for forming foam of the desired quality (consistency, density etc.).

A test parameter may be any physical quantity relating to the state of the fluid, and may include, without limitation, pressure, temperature, viscosity and flow rate.

In a preferred embodiment at least one test parameter for each fluid is a measure of the temperature of that fluid.

In a preferred embodiment the preset range of temperatures of each of the liquids is from 21° C. to 23° C.

Use of the liquids within this range of temperatures is preferred as the viscosities of each liquid are in the correct range to produce quality foam under typical conditions for use in New Zealand. However, it will be apparent to those skilled in the art that the preferred temperature range in a particular country or part of a country may be dependent on the climate in the region where the foam delivery system is being operated, in which case different temperature ranges may be preferred. In particular, the liquids used to form the foam may be customised for optimum performance under the climatic conditions found in each region.

In alternative embodiments the preset range of temperatures of each of the liquids may be from 15° C. to 30° C.

Foam of acceptable quality may be produced with liquids in this general range. For liquids at temperatures lower than 15° C. the viscosity (particularly of the resin containing liquid) may increase making it more difficult to deliver each of the liquids at the required rate. At temperatures above 30° C. the viscosity of the liquids (particularly of the liquid containing resin) may decrease, again making it more difficult to deliver each of the liquids at the required rate.

In a preferred embodiment at least one test parameter for each fluid is a measure of the pressure of that fluid.

In a preferred embodiment at least one test parameter for each fluid is a measure of an output pressure of that liquid.

In a preferred embodiment the preset allowed range of values for air from the fluid controller includes an output pressure in the range from 80 kPa (˜12 psi) to 125 kPa (˜18 psi).

In a preferred embodiment the preset allowed range of values for the first liquid containing catalyst includes an output pressure in the range from 55 kPa (˜8 psi) to 200 kPa (˜28 psi).

In a preferred embodiment the preset allowed range of values for the second liquid containing resin includes an output pressure in a range from 100 kPa (˜14 psi) to 180 kPa (˜26 psi).

In a preferred embodiment the preset allowed range of values for air from the fluid controller includes an output pressure in the range from 80 kPa (˜12 psi) to 125 kPa (˜18 psi).

These pressure ranges are appropriate for liquids at temperatures within the preferred temperature range. The ranges of pressures given above are those required to deliver each liquid (in the preferred temperature range) and the air in the correct amounts and flow rates to produce quality foam in the mixing chamber. If the pressures of either of the liquids or the air move outside of the preferred ranges the result may be an incorrect ratio of liquids and air in the mixing chamber, and therefore poor quality foam.

The above allowed ranges of values are appropriate for production of foam under conditions commonly found in New Zealand. As will be apparent to those skilled in the art, the conditions for insulation foam production in other countries may differ and result in different allowed ranges of values from those given above.

Generally, a measured pressure outside of the preferred ranges may be indicative of a problem within the foam delivery system, requiring production of foam to stop until the problem is identified and corrected.

According to another aspect of the present invention there is provided a foam delivery system for delivery of foam insulation into a cavity, including:

a fluid controller configured to receive a plurality of fluids, at least two of which are liquids, and to measure a test parameter for each fluid; and

a mixing chamber configured to receive a plurality of fluids from the fluid controller and to mix the fluids to form a foam for installation into the cavity of a building;

characterised in that

the fluid controller is configured to stop delivery of all fluids to the mixing chamber if the measured test parameter of any fluid falls outside of a preset allowed range of values for that fluid.

A foam delivery system according to the present invention is intended for on the site of a building or structure, such as (without limitation) a domestic dwelling. This requires that the components of the system be portable so that they may be moved as required from site to site and around sites. In general, as the foam delivery system is normally operated by one person only, a portable system should be understood to refer to an apparatus, or where the system consists of a number of distinct components, the components, that may be readily moved by one person only.

A portable apparatus therefore is constrained as to size and shape, as well as weight. While the applicant envisages that a component of the system could be mounted onto a vehicle, such as a trolley or cart, so that one person could move it around, preferably it is intended that the component parts (other than filled liquid reservoirs which may require a trolley or similar to shift onto a site) be such that they can be lifted by one person.

In order to meet the operational requirements of portability, fitness for purpose and cost effectiveness, the fluid controller in a preferred embodiment will meet the following criteria:
weigh less than or about 30 kg;
deliver each liquid at the same flow rate, preferably within 2% variation or less; and
can be manufactured at commercially acceptable cost.

In a preferred embodiment the fluid controller weighs less than 30 kg.

Reference to a fluid controller throughout the specification should be understood to mean a device configured to receive the component fluids required to form foam, and to deliver preset amounts of the component fluids to a mixing chamber.

A fluid controller is one of the main components of a foam insulation system. A fluid controller weighing less than 30 kg has the advantage that it can be moved by one person, thus contributing to the portability of the foam insulation system.

According to another aspect of the present invention there is provided a fluid controller for delivery of a plurality of input fluids, at least two of which are liquids, including

a delivery mechanism for each fluid, and

at least one test parameter transducer for each fluid configured to produce an output measure of a test parameter associated with each fluid, and

a control system configured to receive the output of each test parameter transducer and to issue a termination signal configured to stop each of the delivery mechanisms if the measured test parameter of any fluid falls outside of a preset range of values for that fluid.

Reference to a test parameter transducer throughout this specification should be understood to refer to any device for converting a non-electrical input signal relating to a test parameter into an electrical signal output.

In a preferred embodiment at least one test parameter transducer for each fluid is configured to produce an output measure of the pressure of the fluid.

In a preferred embodiment at least one test parameter transducer for each fluid is configured to produce an output measure of the temperature of the fluid.

In a preferred embodiment at least one test parameter transducer for each liquid is configured to produce an output measure of an output pressure of the liquid.

Measurement of the temperature and pressure of each fluid may be used to determine that the fluid controller is operating in the desired range. Conversely, and importantly, a variation in temperature or pressure away from the desired values may indicate a malfunction of the apparatus and the need to halt production of foam.

In a preferred embodiment the preset allowed range of values for the liquid containing resin includes an output pressure in a range from 100 kPa (˜14 psi) to 180 kPa (˜26 psi).

In a preferred embodiment the preset allowed range of values for the liquid containing catalyst includes an output pressure in the range from 55 kPa (˜8 psi) to 200 kPa (˜28 psi).

In a preferred embodiment the preset allowed range of values for air from the fluid controller includes an output pressure in the range from 80 kPa (˜12 psi) to 125 kPa (˜18 psi).

In a preferred embodiment the control system includes a control device.

In a preferred embodiment the control device is a Programmable Logic Controller.

While there are clear advantages in using a Programmable Logic Controller (PLC) in the foam insulation system, other forms of computerised data processing could be used, for example a suitably configured lap top computer. However, lap top computers (and other types of computer) generally lack the multiple inputs and outputs and specialised adaptation to industrial conditions that are common with a PLC.

A PLC according to the present invention may be programmed to receive data from a test parameter transducer at specified intervals and to compare that data with a predetermined range of acceptable values for the data. If the result of the comparison is that the data is outside the range of acceptable values then the PLC issues an instruction to shut down all the delivery mechanisms, thus halting further production of foam.

The PLC may also be programmed to record data from the transducers so that the performance of the apparatus over time can be monitored. This kind of information may be used to determine when a machine requires maintenance, for example.

According to another aspect of the present invention there is provided a fluid controller for delivery of a plurality of fluids, at least two of which are liquids, including

a master pump, and

an auxiliary pump for each liquid

characterised in that

each auxiliary pump is coupled to operate substantially in unison with the master pump.

In a preferred embodiment the master pump is pneumatically driven.

An advantage of driving the master pump pneumatically is that it may reduce the weight of the fluid controller in comparison with other ways of driving the master pump which require addition of a motor. Air for a pneumatically driven pump may be delivered by a compressor which is separate from the fluid controller and therefore does not add weight to it. However, it will be appreciated by those skilled in the art that the master pump may be driven by means other than pneumatically, such as by electric motor, and that reference to pneumatic drive only throughout this specification should not be seen as limiting.

The foam insulation system of the present invention includes a portable fluid controller having a delivery mechanism preferably configured to separately draw a first liquid (A) from a first reservoir and a second liquid (B) from a second reservoir into the fluid controller.

The fluid controller is also configured to receive compressed air. Typically this may be from a compressor although any other source of compressed air, such as a cylinder filled with pressurised air, may be used. In each case the reservoir for the air is considered to be the source of the compressed air.

In a preferred embodiment the fluid controller is configured to deliver each of the at least two fluids at substantially the same flow rate.

Reference to the same flow rate should be understood to mean the flow rates of the two or more fluids differ by less than 4%.

In a preferred embodiment the flow rates of the at least two fluids differ by less than 2%.

In order to produce foam of the correct consistency, the fluid controller should be configured to separately deliver amounts of each liquid in the required ratio (typically around 1:1 although other ratios may be used) as well as the correct amount of air for mixing with the liquids. These requirements place considerable limitations on the configuration of a fluid controller.

In general there is a relationship between the constitution of each fluid and the required flow rate for each fluid in order to produce foam of the correct consistency. The applicant has found that it is preferable to adjust the constitution of each fluid (prior to it entering the fluid controller) to that which will provide foam of the correct consistency when the two liquids are delivered at the same rate, rather than to separately adjust the flow rate to suit each liquid. In particular, as discussed in more detail below, it is preferable to set the fluid controller to deliver substantially equal flow rates for each fluid so that no further adjustment of flow rate is required. However, it will be appreciated that other arrangements may be used resulting in unequal flow rates.

The delivery mechanism may be a pair of pumps, one for each liquid, configured to draw a liquid from its reservoir and to move a quantity of the liquid into a connector connected to a mixing chamber. The connector may generally be considered to be a hose, although in some instances a pipe may be used in some portions of a connector.

In alternate embodiments the delivery mechanism may be a pair of pumps, one for each liquid, configured to receive liquid from its reservoir and to move a quantity of the liquid into a hose connected to a mixing chamber. An example of such an embodiment may be one in which the liquid is provided in a pressurised reservoir.

Generally any type of pump (configured to pump liquids) may be used, including (without limitation) piston, rotary and diaphragm pumps. However, in practice there can be difficulty in setting up two pumps (one for each liquid) such that they reliably work in unison to provide the same amount of liquid, particularly when, as in this application, the viscosities of the liquids are quite different.

The applicant experienced difficulty finding piston, rotary or diaphragm pumps that can reliably deliver the precise amounts of liquid required for optimum production of foam, and that met the weight and cost criteria outlined above.

For example, the applicant found a rotary pump that could produce the required flow rates at the required precision. However, two pumps were required, each costing around $1,700 and weighing 12 kg. Furthermore, the pumps required an electric motor having a double ended drive shaft (i.e. extending each side of the motor), which added a further 7 kg to the weight. Quite apart from the cost of these components, the combined weight exceeded the weight criteria, without any of the other components of the fluid controller.

It was found difficult to connect two diaphragm pumps so that they reliably produced the same flow rates for each liquid. Furthermore, diaphragm pumps proved to be not suitable for reliably delivering a liquid with relatively high viscosity (relative to water) such as the resin containing liquid (the second liquid,(B)). Weight and cost was also increased by the need for an electric motor to drive the diaphragm pumps.

In a preferred embodiment the delivery mechanism includes a pneumatically driven master cylinder.

An advantage of pneumatic operation is that compressed air is provided to the fluid controller (as part of the requirements to produce foam) and part of this supply may be used to operate the delivery mechanism in a cost effective manner. A further advantage is that a separate motor is not required (as would be the case for piston, rotary or diaphragm pumps) which may reduce the weight of the delivery mechanism. This is an important factor in enabling portability of the fluid controller.

An hydraulically operated system may be used (instead of pneumatically operated) although this would involve additional circuitry and pumps for the hydraulic fluid and generally would increase the weight and cost of the apparatus.

In a preferred embodiment the pneumatically driven master cylinder is rigidly coupled to a cylinder fluid pump for each liquid.

Reference to a cylinder fluid pump throughout this specification should be understood to refer to a cylinder containing a double acting piston, the pump being configured to pump liquids.

Preferably the cylinder fluid pump is a cylinder of a pneumatic system, adapted to pump liquids.

Preferably the cylinder fluid pump is formed from a lightweight alloy.

An advantage of using a lightweight alloy is that the weight of each pump can be relatively low, for example in comparison with use of a cylinder formed from steel.

Preferably the bore of the cylinder fluid pump is coated with polytetrafluoroethylene (PTFE).

PTFE coated surfaces have a number of advantages in the present application. The coating may significantly reduce friction as the piston moves through the cylinder, and of the liquids against the inner walls of the cylinder, both of which reduce the power required to drive the pump.

PTFE does not react with the chemicals in the liquids used to produce foam. This may significantly decrease the amount of corrosion of the walls of the cylinder, thus increasing the useful lifetime of the pumps.

Preferably the PTFE is a product such as Teflon™,

An important aspect of production of foam of the correct composition involves providing correct amounts of the two constituent liquids to the mixing chamber. Liquid A and liquid B are generally mixed (prior to the start of foam production) in concentrations such that the correct chemical balance is achieved by mixing together substantially equal amounts of each liquid.

A delivery mechanism as described above may be configured such that each stroke of the master cylinder causes operation of each of the cylinder fluid pumps at substantially the same time. In a preferred embodiment this is achieved by rigidly coupling the pneumatically driven master cylinder to each of the cylinder fluid pumps, so that movement of the piston in the master cylinder results in essentially the same movement of the piston in each cylinder fluid pump.

As the length of each stroke of the master cylinder may be controlled accurately this arrangement may be configured to provide substantially simultaneously the same flow rate for each liquid.

The cylinder liquid pumps and the master cylinder may be rigidly coupled in series (i.e. in-line) or in parallel (side by side).

In a preferred embodiment each cylinder fluid pump is connected in parallel with the master cylinder.

This arrangement has the advantage that the physical dimensions of the delivery mechanism (and in particular the length) may be reduced by mounting the cylinder fluid pumps on either side of the master cylinder to form a physically compact arrangement.

The fluid delivery mechanism may be conveniently located on a base plate which may be attached to the fluid controller such that the delivery mechanism may be readily removed, for example for maintenance, by removal of the base plate.

In a preferred embodiment the portable fluid controller includes a surge control.

Reference to a surge control throughout this specification should be understood to refer to a device used to even out fluctuations in flow rate of a substance.

The output (i.e. flow rate of a liquid) from a cylinder fluid pump may vary momentarily at the end of each stroke as the direction of movement of the piston is reversed. A surge control may be used to even out any fluctuation in the flow rate caused by this effect, thus increasing the uniformity of the flow rate of liquid delivered by the delivery mechanism

The fluid delivery mechanism, as described above, meets the criteria outlined above for the components of a fluid controller. It is configured to deliver each liquid at essentially the same flow rate. It does not require an on-board motor as the power is supplied by an external source of pressurised air, saving additional weight and cost. Furthermore the cylindrical pumps are formed from relatively lightweight alloy, are relatively inexpensive, and, when rigidly coupled in parallel, form a compact unit, which together aid portability of the fluid controller.

In a preferred embodiment the fluid controller includes a Human Machine Interface.

Reference to a Human Machine Interface (HMI) throughout this specification should be understood to refer to a device that allows an operator to communicate with the control system.

An HMI, in the form of a control panel, may be configured to display information received from the PLC relating to the internal operating conditions of the foam insulation system, including any fault conditions, and to enable information relating to external conditions to be input to the PLC (such as, without limitation, the date, time, location and type of job undertaken).

The HMI may also be used to input instructions to the PLC, for example to run a pre-loaded programme.

In a preferred embodiment the control panel includes a visual display unit.

In a preferred embodiment the control panel includes a user input device.

A visual display unit may be an LCD display or any other such device configured to visually display information from the PLC. A user-input device may be a keyboard or keypad or any other such device by which an operator can input information into the PLC.

An LCD display may, for example, display an error message if the apparatus is shut down as a result of a test parameter being outside of the preset allowed range of values. An operator may then determine the source of the error and take the appropriate action.

The control panel may also be used to input into the PLC further information relating to the current job being undertaken, such as the date, time, location and type of job undertaken so that a record of use may be made over time.

The PLC may be programmed to accept input from the keyboard relating to the type of cavity to be filled, e.g., by an operator inputting a key corresponding to the nature of the cladding (brick veneer, weatherboard etc).

This information may be used by the programme in the PLC (for example by reference to a look-up table) to set the appropriate pump rate for the master cylinder, and hence the appropriate range of allowed pressures for the fluids, for the specific job.

The PLC may be programmed to use the cladding-type input also to identify the correct nozzle for filling the particular cavity and to display the information on the visual display unit, thus reducing the likelihood of an incorrect nozzle size being used.

In the event that an incorrect nozzle size is used, the pressures measured by the test parameter transducers are likely to be outside of the preset allowed range of pressures (determined by the programme in the PLC) resulting in the PLC stopping production of foam (by stopping the pump in the fluid delivery mechanism and shutting off the mixing gun) and causing an error message to be displayed on the visual display unit of the HMI.

This may overcome a problem with the prior art devices where incorrect selection of a nozzle by an operator can lead to poor quality foam being produced and increased costs for the job.

Data may also be accumulated in the PLC regarding the history of usage of the machine and any errors encountered. This may include tracking data on the locations and times where the machine has been operated, as provided by GPS for example. This information may be stored, for example on a hard disc, for subsequent retrieval and analysis. For example, if a query arises regarding a particular job after it has been finished, it may be possible to use the stored data to review the installation process throughout the job and identify any possible problems with the foam.

The PLC may be programmed to alert an operator of the need for maintenance of the machine (or components of it) by causing an appropriate message to be displayed on the visual display unit.

As the amounts of fluid delivered from the fluid controller to the mixing chamber are controlled by the programme in the PLC, there is no requirement for operator-controlled adjustment of flow at the mixing gun. All that is required is a switch to start or stop production of foam. The condition of the switch may be monitored by the PLC through a suitable connection, typically a cable.

Preferably the PLC is programmed to control an output valve on the fluid controller for each fluid.

Preferably the PLC is programmed to control an input valve on the mixing gun for each fluid.

PLC controlled solenoid valves (for example) may be used to control the flow of fluid through a hose from the fluid mixing apparatus into the mixing gun. Such valves replace the need for the operator-controlled valves of the prior art mixing guns.

In a preferred embodiment the control device is programmed to open an input valve on the mixing gun before opening a corresponding output valve on the fluid controller.

An advantage of this arrangement is that opening the mixing chamber shortly before beginning delivery of liquid may reduce any build up of pressure in the connecting hose due to the initial surge of liquid.

According to another aspect of the present invention there is provided a portable fluid controller substantially as described above, wherein the control system is configured to receive the output of at least one test parameter transducer configured to measure a test parameter of at least one of said fluids at a distance from the fluid controller and to issue a termination signal configured to stop each said delivery mechanism if said measured test parameter deviates from a preset range of values.

In a preferred embodiment the mixing gun includes one or more test parameter transducers.

A test parameter transducer may be used to monitor a test parameter (such as the pressure or temperature or any other relevant measure) of a fluid in the mixing gun. Data from a transducer in the mixing gun may be transmitted to the PLC in the fluid controller, for example through a cable or via a telecommunications link. Analysis. of such data may be useful as a diagnostic tool for the mixing apparatus.

For example, comparison of the output pressure for a fluid with the input pressure at a mixing gun may be used to ensure the integrity of the flow path along the connections between the two. A drop in pressure, for example, may indicate a leak or constriction in the connecting hose. Should this occur the PLC may be programmed to halt production of the foam until the problem is identified and corrected.

In a preferred embodiment the mixing gun includes a mixing gun switch.

In a preferred embodiment the mixing gun switch is a push button.

Reference to a mixing gun switch as a push button throughout this specification should be understood to refer to a switch that is activated by depressing a button. It will be appreciated that many other types of switch could be used for this function and that reference to a push button only throughout this specification should not be seen as limiting.

A push button switch may be configured to send a number of instructions to the PLC representing a number of operations, depending for example on the duration of depression or the frequency of depressions. The instructions, in the form of signals, may be sent to the PLC via a connector, such as a cable, or any other means well known in the art, for example by telecommunications.

In a preferred embodiment the mixing gun switch is configured to send an on/off signal to the PLC.

An operator, when ready to begin production of foam, may depress the push button thus sending an “on” signal to the PLC. The PLC may be programmed to receive the “on” signal and to initiate production of foam (i.e., open the solenoid valves on the fluid controller and mixing gun and commence delivery of the fluids.

Similarly, on receipt of an “off” signal, which may be a further (delayed) push of the button or some other sequence of pushes, the PLC may be programmed to stop delivery of the fluids and to shut off the solenoid valves.

Typical mixing guns, as currently used, include an operator-controlled valve for controlling the flow of air into the mixing chamber(s) of the mixing gun, as well as a valve for flow of each liquid. The air valve is used by an operator to control the density of the foam. A mixing gun for use with the present invention does not require these manually operated valves, as fluid and air flow to the mixing gun is controlled elsewhere.

An advantage of the current invention is that an operator no longer has to adjust flow through three valves to turn foam production on or off, but can operate the mixing gun with the use of an on/off switch only, for example by a single push of the button. This allows the operator to concentrate on application of the foam without the added concern of controlling its quality.

In a preferred embodiment the mixing gun switch is configured to transmit a purge signal to the PLC.

The PLC may be programmed to purge the mixing gun on instruction from the operator via the mixing gun switch. For example, the PLC may be programmed to recognise a purge signal from the button. On receipt of the purge signal the PLC may be programmed to stop the flow of liquids to the mixing gun and to force air through the mixing gun, thus purging the mixing gun of any remaining material.

In a preferred embodiment the purge signal is initiated by holding down the push button for a preset minimum time.

In other embodiments the purge signal may be initiated by repeated pushes of the button.

An advantage of this automated purge procedure is that the mixing gun may be purged by a simple operation of the mixing gun switch, rather than the manual adjustment of valves for each fluid as in the mixing guns of the prior art.

Furthermore, the act of purging the mixing gun, which must be carried out whenever there is a pause in production of foam of more than a few seconds, does not change the operational settings for the gun as these are set by the programme in the PLC controlling the fluid controller. Therefore foam production can restart (for example by an operator depressing the button) without requirement to reset the operating conditions for the foam insulation system.

In contrast, the need to shut off the valves for each fluid in mixing guns of the prior art can change the operational settings (which are set by the reservoir pressure regulators) which, if not properly reset, can lead to the production of poor quality foam or the requirement for recalibration.

In some embodiments the PLC may be programmed to purge the mixing gun if not initiated by the operator within a preset time delay following a stop in foam production. The preset time delay could, for example, be set at 80% of the gel time of the foam. The advantage of this is that foam may be removed from the mixing gun (including the extension and nozzle) before it has time to gel. Without this feature, an operator may stop application of foam but not purge the system in time to prevent the foam in the mixing gun from gelling, resulting in the need to clean the mixing gun prior to restarting application of foam, with a consequent increase in time and costs for the job.

In a preferred embodiment the mixing gun switch is configured to transmit a flush signal to the PLC.

The PLC may be programmed to flush the foam insulation system (including the fluid controller, mixing gun and all connectors) on instruction from the operator via the mixing gun switch. For example, the PLC may be programmed to recognise a flush signal from the button. On receipt of the purge signal the PLC may be programmed to flush the system, including the mixing gun, fluid delivery mechanism and connecting hoses, of any remaining material.

This can occur, for example, by an operator removing the hoses for each liquid from the reservoirs and inserting them into a reservoir containing water or other solvent. On receipt of the flush signal the PLC may then set the fluid delivery mechanism to pump water through the entire system to flush out any remaining material.

In a preferred embodiment the purge signal is initiated by depression of the mixing gun switch for a preset minimum time.

In other embodiments the purge signal may be initiated by repeated depressions of the button.

According to another aspect of the present invention there is provided a kit set of components for a fluid mixing system including

a mixing chamber and

a fluid controller for delivery of a plurality of input fluids, at least two of which are liquids, including at least one delivery mechanism and at least one test parameter transducer for each fluid configured to produce an output measure of a test parameter associated with each fluid, and a control system configured to receive the output of each test parameter transducer and to issue a termination signal configured to stop the one or more delivery mechanism if the measured parameter falls outside of a preset allowed range of values.

According to another embodiment of the present invention there is provided a kit set of components for a fluid mixing system substantially as described above, wherein the mixing chamber is a mixing gun.

In some embodiments the kit set may include a set of connectors for transferring liquid from the fluid mixing apparatus to the mixing chamber.

A kit set may also include a set of connectors for transferring data between the fluid mixing apparatus and the mixing chamber.

A fluid mixing system, in the form of a foam insulating machine of the present invention provides many advantages over the operator-controlled prior art devices.

In practical terms the most important advantage is the inclusion of a multi-component Quality Control system to ensure the installed insulation is of the correct standard. In particular, variations in the quality of foam, as can be produced by operator error or inattention in an operator-controlled system, may be reduced as the fluid controller of the present invention is programmed to deliver fluids to the mixing gun only so long as the amounts of each fluid stay within preset limits, and otherwise to stop delivery of all fluids. As a result the consistency and density of any foam produced may be kept within acceptable bounds.

A customer may therefore have increased confidence that the installed foam will provide the desired insulation and will have an acceptable lifetime (e.g., not crumble). This increased level of confidence may encourage more people to retrofit insulation into buildings, with a consequent lowering of the energy used in heating or cooling of the buildings.

A further advantage is that the skill of the operator is no longer a limiting factor in producing quality foam. The foam insulation system of the present invention may be operated by a person of normal skill without extensive training, which may lead to lower training costs in comparison with training good operators for the operator-controlled prior art systems. Hence a shortage of trained operators may be less of a problem as new operators can be trained in a relatively short time.

This also opens the opportunity for the present invention (with suitable operating instructions) to be used in the Do-It-Yourself market, for example by leasing the foam insulation system, which may further increase uptake of the foam insulation technology and result in an increase in the number of insulated dwellings.

The interior layout of the fluid controller is such that the PLC, HMI and the associated electronics are preferably located in a compartment that is partitioned from the remaining components. This has the considerable advantage that if a leak occurs in the delivery mechanism or associated connectors, the problem is isolated and in particular, the electronics may be protected from contact with the fluid and any consequent damage.

Another advantage arises from the use of pneumatically driven cylinders to control the delivery of fluids from the fluid controller. The pneumatically driven cylinder is driven by compressed air provided, for example, by a portable compressor. This removes the need for a separate motor to drive the pumps, thus saving space and weight. The use of cylinder fluid pumps formed from light weight alloy also reduces the weight in comparison with other types of pump. These are important factors in producing a portable system suited to on-site operation.

The arrangement of the fluid delivery mechanism, in which the cylinder fluid pumps and master cylinder are arranged side by side, saves space in comparison with an in-line arrangement. The rigid connection of the cylinder fluid pumps for each liquid to the master cylinder helps ensure that each liquid is delivered with substantially the same flow rate (unless there is a fault in the system).

An HMI may be used to advantage to input data into the PLC relating to external conditions, such as the nature of the cavity to be filled (type of construction), as well as data pertinent to the history of operation of the machine, including date, time of use, etc. This data may be accumulated in the PLC for subsequent analysis of performance, and to alert an operator to the need for maintenance of the system. The applicant is not aware of such features being available in the prior art operator-controlled systems.

In summary, some advantages of the present invention are:
Production of insulation foam is quality controlled to consistently produce foam of the desired consistency and density, independently of the skill level of the operator;
Only foam of the desired quality is produced, providing quality assurance for the consumer;
Data about each job is collected enabling future analysis to assess the quality control of each job and of the performance of the fluid controller;

The fluid controller is portable, is programmed to deliver each liquid at the required flow rate, and is cost effective.

### BRIEF DESCRIPTION OF DRAWINGS

Further aspects of the present invention will become apparent from the following description which is given by way of example only and with reference to the accompanying drawings in which:

FIG. 1 shows a schematic side view of the layout of some of the components of a portable fluid controller according to one embodiment of the present invention;

FIG. 2 shows a schematic plan view of the layout of some of the components of a portable fluid controller according to one embodiment of the present invention;

FIG. 3(a) shows a schematic view of an end of a portable fluid controller according to one aspect of the present invention;

FIG. 3(b) shows a schematic view of another end of a portable fluid controller according to one aspect of the present invention; and

FIG. 4 shows a schematic representation of a fluid mixing system according to another embodiment of the present invention.

### BEST MODES FOR CARRYING OUT THE INVENTION

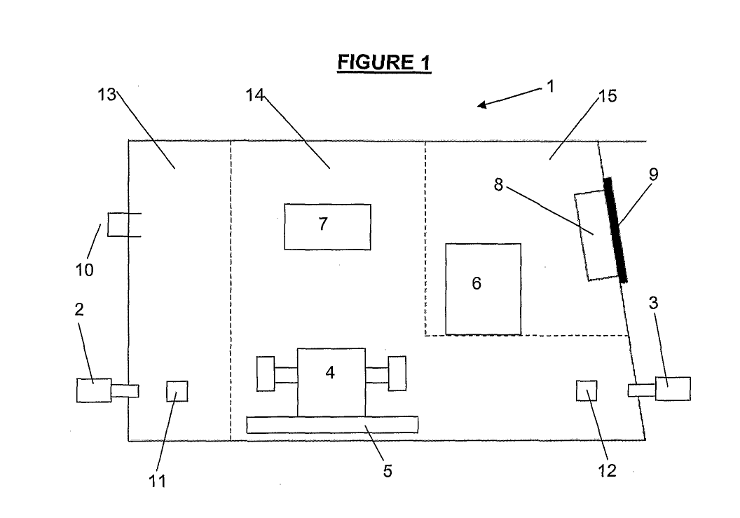

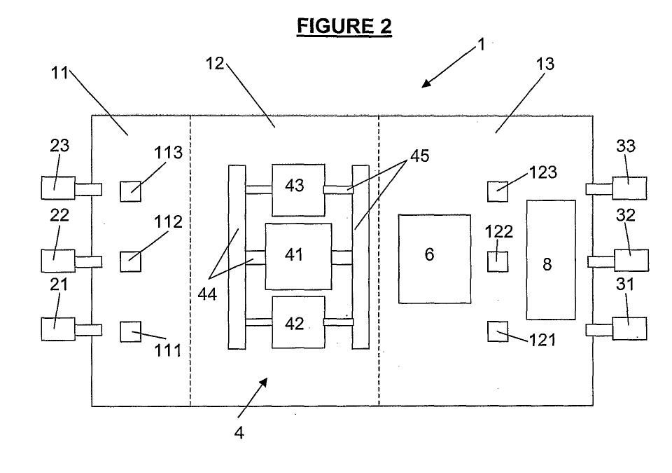

A portable fluid controller according to one embodiment of the present invention is indicated by arrow (1) in FIG. 1 and FIG. 2.

FIG. 1 is a schematic drawing of a possible layout of the main components of the portable fluid controller (1) as viewed from a side.

Fluid inlets (2, 21, 22, 23) and fluid outlets (3, 31, 32, 33) are configured to enable fluid to flow into and out of the portable fluid controller (1) respectively. Only one inlet (2) and outlet (3) is shown in the side view in FIG. 1.

An aperture (10) enables electrical power to be cabled into the fluid controller.

Test parameter transducers (11, 111, 112, 113), in the form of pressure and/or temperature sensors, are located near the fluid inlets (2, 21, 22, 23).

Further test parameter transducers (12, 121, 122, 123), in the form of pressure and/or temperature sensors, are located near the fluid outlets (3, 31, 32, 33).

A fluid delivery mechanism (4) is mounted on a base plate (5). The base plate (5) is attached to the base of the portable fluid controller (1) such that it may be easily removed with the delivery mechanism (4), for example for ease of maintenance or replacement of the delivery mechanism (4).

The fluid delivery mechanism (4) includes a pneumatically driven master cylinder (41). The master cylinder (41) is coupled in parallel to a pair of cylinder fluid pumps, (42) and (43), one for each liquid line. The cylinder fluid pumps (42) and (43) are formed from light weight alloy material. Each cylinder fluid pump (42), (43) includes a double action piston. The inner surfaces of the cylinder fluid pumps (42) and (43) are coated with Teflon™.

A control system in the form of a programmable logic controller (PLC) (6) is programmed to receive the output of each test parameter transducer (11, 111, 112, 113, 12, 121, 122, 123) and to issue a termination signal configured to stop the delivery mechanism (4) if the measured parameter deviates from a preset range of values.

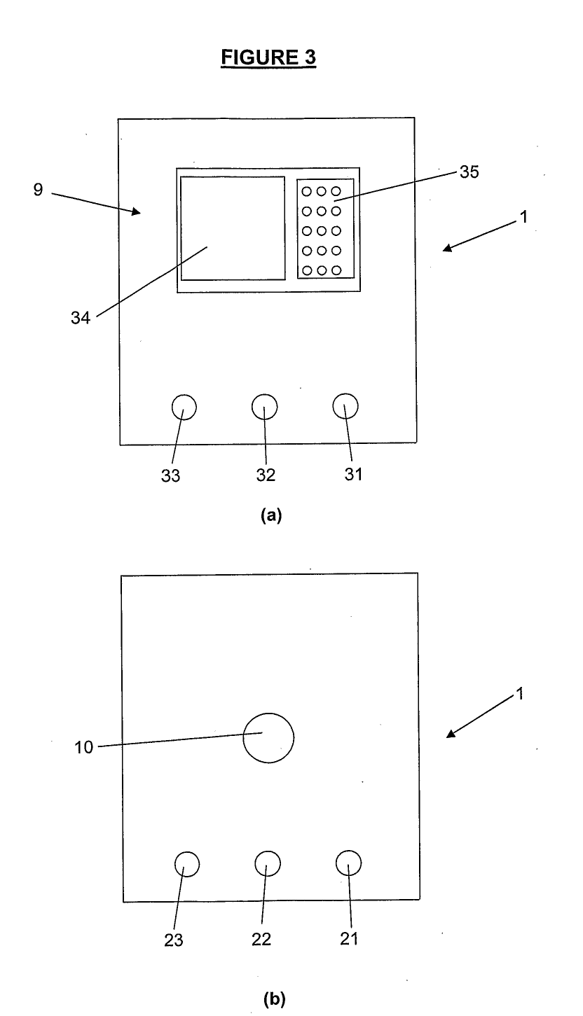

The PLC (6) is also programmed to transmit to and receive information from a Human Machine Interface (HMI) (8). The HMI (8) includes a panel (9) mounted on the outside casing of the fluid controller (1). The panel (9) includes a visual display unit in the form of an LCD display (34) and a user input device in the form of a key pad (35), as shown schematically in FIG. 3.

The interior space of the fluid controller (1) is divided into three separate compartments. An input control compartment (13) houses the input test parameter transducers (11, 111, 112, 113) and other control and monitoring mechanisms as required.

A drive and metering compartment (14) houses the fluid delivery mechanism (4) and the surge control (7), and the output test parameter transducers (12, 121, 122, 123).

An electronic compartment (15) houses the PLC (6) and HMI (8) and associated electronics (not shown).

The compartments (13, 14 and 15) are constructed such that the electronic components housed in the electronic compartment (15) are protected from any spillage of liquid, particularly in the drive and metering compartment (14).

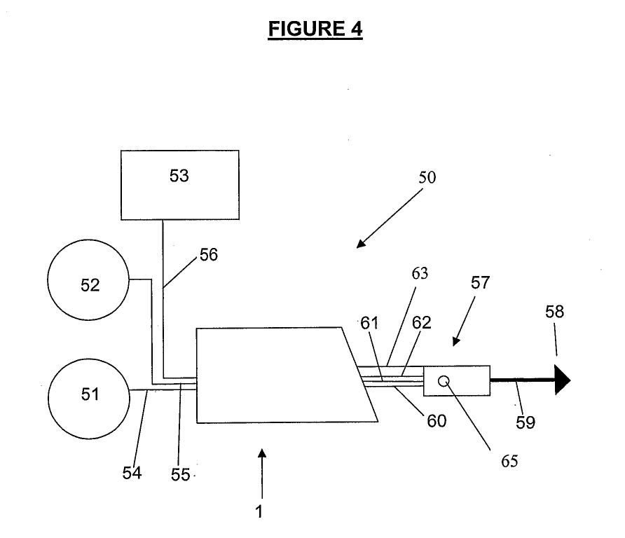

A fluid mixing system, in the form of a foam insulation machine, is generally indicated by arrow (50) in FIG. 4.

A first reservoir (51) and a second reservoir (52) are in the form of drums which, in use, hold a first and second liquid respectively. One liquid includes a catalyst and a foaming agent while the other liquid is a resin. The reservoirs (51) and (52) are connected by hoses to the inlets (21) and (23) respectively on the fluid controller (1).

A third reservoir, in the form of an air compressor, provides compressed air to the fluid controller (1) through a hose (56).

A mixing chamber, in the form of a foam mixing gun (generally indicated by arrow 57) receives liquid through hoses (60) and (62) and air through hose (61) from the fluid controller (1). The foam mixing gun (57) is configured to first mix air with the liquid containing the catalyst and foaming agent to form an air/catalyst foam. In a second stage the second resin containing liquid is mixed with the air/catalyst foam to produce foam insulation material.

The foam mixing gun (57) includes an extension (59) which is configured to allow the foam insulation material to flow to the nozzle (58).

The operation of the foam mixing gun is turned on or off by operation of a mixing gun switch in the form of a push button (65). The push button (65) replaces the three operator-operated valves (one for each hose) typical of foam mixing guns of the prior art.

Holding down the push button (65) for a predetermined length of time is used to initiate purging of the mixing gun (57)

Depressing the push button (65) twice sequentially initiates flushing of the foam insulation system (50)

A connector, in the form of a multiple-wire cable (63) connects the PLC to the push button (65) as well as carrying electrical power to the mixing gun (57).

The mixing gun includes three solenoid valves (not shown), one for each of the hoses (60, 61, 62) delivering the fluids. The solenoid valves switch flow on or off under control by the PLC (6).

The PLC is programmed such that there is a delay between the opening of the solenoid valves at the mixing gun (57) and the subsequent opening of the solenoid valves at the fluid controller (1). This delay reduces the surge effect of turning on the fluids to the mixing gun (57).

In operation the components of the foam insulation system are delivered to the job site. An operator then connects the fluid reservoirs containing each liquid, and the compressor, to the inlet connections on the fluid controller using suitable hoses. Electrical power is connected to the fluid controller to power the PLC and HMI. (A battery could be used for this purpose but such would add considerably to the weight and potentially the size of the apparatus, making it relatively less portable).

Suitable hoses for each fluid, typically up to around 40 m, are connected to the outlets of the fluid controller and to the mixing gun. Relatively long hoses are used for this purpose to enable the operator to use the gun in a variety of locations within the radius provided by the length of the hoses, without the need to relocate the rest of the equipment.

The operator then inputs a range of information relative to the job into the PLC using the keypad. This information includes the date, time, address of the job site, and type of structure/cavity to be filled. Other information, such as an identifier for the operator and weather conditions may also be input at this stage.

The visual display unit may be used to display the correct nozzle type to be attached to the mixing gun for the specific job.

With the foam insulation system connected up and powered, the foam production is controlled by the operator using the switch on the mixing gun.

If an error is detected by the PLC, for example a test parameter outside of its allowed range of values, the PLC shuts the fluid delivery mechanism off and displays an error message on the visual display unit. This is read by the operator and appropriate corrective action taken.

Data pertinent to the job and the operation of the system is stored by the PLC. This is used for subsequent analysis of the performance of the foam insulation system and its components, as well as for analysis on a job-by-job basis.

Aspects of the present invention have been described by way of example only and it should be appreciated that modifications and additions may be made thereto without departing from the scope thereof as defined in the appended claims.

1. A method of delivering foam insulation into a cavity, the foam being formed from a plurality of fluids, at least two of which are liquids,
comprising the steps of:
a) receiving each fluid into a fluid controller;
b) forming a foam in a mixing chamber by combining the fluids received from the fluid controller; and
c) delivering the formed foam into the cavity;
d) measuring a test parameter for each fluid in the fluid controller; and
e) stopping delivery of all fluids if the measured test parameter of any fluid falls outside of a preset allowed range of values for that fluid;
wherein steps d) and e) are performed independently of an operator.

2. The method of delivering foam insulation as claimed in claim 1 wherein a first liquid includes a catalyst.

3. The method of delivering foam insulation as claimed in either one of claims 1 wherein a second liquid includes resin.

4. The method of delivering foam insulation as claimed in claim 3 wherein the resin is urea formaldehyde.

5. The method of delivering foam insulation as claimed in claim 1 wherein the mixing chamber is the mixing chamber of a mixing gun.

6. The method of delivering foam insulation as claimed in claim 1 wherein at least one test parameter for each fluid is a measure of the pressure of that fluid.

7. The method of delivering foam insulation as claimed in claim 1 wherein at least one test parameter for each fluid is a measure of the temperature of that fluid.

8. The method of delivering foam insulation as claimed in claim 1 wherein the preset allowed range of values for each of the liquids includes temperatures from 15° C. to 30° C.

9. The method of delivering foam insulation as claimed in claim 1 wherein at least one test parameter for each liquid is a measure of an output pressure of that liquid.

10. The method of delivering foam insulation as claimed in claim 2 wherein the preset allowed range of values for the first liquid including catalyst includes an output pressure in the range from 55 kPa (˜8 psi) to 200 kPa (˜28 psi).

11. The method of delivering foam insulation as claimed in claim 3 wherein the preset allowed range of values for the second liquid including resin includes pressures from 100 kPa (˜14 psi) to 180 kPa (˜26 psi).

12. The method of delivering foam insulation as claimed in claim 1 wherein one fluid is air.

13. The method of delivering foam insulation as claimed in claim 12 wherein the preset allowed range of values for air from the fluid controller includes an output pressure in the range from 80 kPa (˜12 psi) to 125 kPa (˜18 psi).

14. A foam delivery system for delivery of foam insulation into a cavity, comprising:
a fluid controller configured to receive a plurality of fluids, at least two of which are liquids, and to measure a test parameter for each fluid;
a mixing chamber configured to receive a plurality of fluids from the fluid controller and to mix the fluids to form a foam for installation into the cavity; and
wherein the fluid controller is configured to stop delivery of all fluids to the mixing chamber if the measured test parameter of any fluid falls outside of a preset allowed range of values for that fluid.

15. The fluid controller for a foam delivery system as claimed in claim 14 wherein at least one test parameter transducer for each fluid is configured to measure the pressure of the fluid.

16. The fluid controller for a foam delivery system as claimed in claim 14 wherein at least one test parameter transducer for each fluid is configured to measure the temperature of the fluid.

17. The fluid controller for a foam delivery system as claimed in claim 14 wherein at least one test parameter transducer for each liquid is configured to measure an output pressure of the liquid.

18. The fluid controller for a foam delivery system as claimed in claim 14 including
a delivery mechanism for each fluid,
at least one test parameter transducer for each fluid configured to produce an output measure of a test parameter associated with each fluid, and
a control system configured to receive the output of each test parameter transducer and to issue a termination signal configured to stop each of the delivery mechanisms if the measured test parameter of any fluid falls outside of a preset allowed range of values for that fluid.

19. The fluid controller as claimed in claim 18 wherein the delivery mechanism includes a master pump, and an auxiliary pump for each liquid wherein each auxiliary pump is coupled to operate substantially in unison with the master pump.

20. The fluid controller as claimed in claim 19 wherein the master pump is driven pneumatically.

21. The fluid controller as claimed in claim 19 wherein the fluid controller is configured to deliver each of the at least two fluids at substantially the same flow rate.

22. The fluid controller as claimed in claim 21 wherein flow rates of the at least two fluids differ by less than 2%.

23. The fluid controller as claimed in claim 18 wherein the delivery mechanism includes a pneumatically driven master cylinder.

24. The fluid controller as claimed in claim 23 wherein the pneumatically driven master cylinder is rigidly coupled to a cylinder fluid pump for each liquid.

25. The fluid controller as claimed in claim 24 wherein each cylinder fluid pump is connected in parallel with the master cylinder.

26. The fluid controller as claimed in claim 15 including a surge control.

27. The fluid controller as claimed in claim 15 including a control device.

28. The fluid controller as claimed in claim 27 wherein the control device is a Programmable Logic Controller (PLC).

29. The fluid controller as claimed in claim 27 wherein the control device is programmed to open an input valve on the mixing chamber before opening a corresponding output valve on the fluid controller.

30. The fluid controller as claimed in claim 27 wherein the control device is configured to receive the output of at least one test parameter transducer configured to measure a test parameter of at least one of said fluids at a distance from the fluid controller and to issue a termination signal configured to stop each said delivery mechanism if said measured test parameter falls outside of a preset allowed range of values.

31. The fluid controller as claimed claim 15 including a Human Machine Interface.

32. The fluid controller as claimed in claim 31 wherein the Human Machine Interface includes a visual display unit.

33. The fluid controller as claimed in claim 31 wherein the Human Machine Interface includes a user input device.

34. The fluid controller as claimed in claim 15 wherein the fluid controller weighs less than 30 kg.

35. A mixing chamber for the foam delivery system as claimed in claim 14 wherein the mixing chamber includes one or more test parameter transducers.

36. A mixing chamber for the foam delivery system as claimed in claim 14 wherein the mixing chamber includes a mixing chamber switch configured to communicate with the fluid controller.

37. The mixing chamber as claimed in claim 36 wherein the mixing chamber switch is configured to send an on/off signal to the fluid controller.

38. The mixing chamber as claimed in claim 36 wherein the mixing chamber switch is configured to transmit a purge signal to the fluid controller.

39. The mixing chamber as claimed in claim 36 wherein the mixing chamber switch is configured to transmit a flush signal to the fluid controller.

40. A kit set of components for a fluid mixing system comprising: a mixing chamber and a fluid controller for delivery of a plurality of input fluids, at least two of which are liquids, including at least one delivery mechanism and at least one test parameter transducer for each fluid configured to measure a test parameter associated with each fluid, and a control system configured to receive the output of each test parameter transducer and to issue a termination signal configured to stop the one or more delivery mechanism if the measured parameter falls outside of a preset allowed range of values.

41. (canceled)

42. (canceled)

43. (canceled)
